(19) United States
(12) Patent Application Publication
(10) Pub. No.: US 2013/0293746 A1
(43) Pub. Date: Nov. 7, 2013

(54) DISPLAY CONTROL DEVICE, DISPLAY CONTROL METHOD, PROGRAM, AND RECORDING MEDIUM

(71) Applicant: SONY CORPORATION, Tokyo (JP)

(72) Inventor: Masaru Iki, Kanagawa (JP)

(73) Assignee: SONY CORPORATION, Tokyo (JP)

(21) Appl. No.: 13/857,267

(22) Filed: Apr. 5, 2013

(30) Foreign Application Priority Data
May 2, 2012 (JP) 2012-105047

(51) Int. Cl. H04N 5/265

(52) U.S. Cl. CPC H04N 5/265
USPC 348/239

(57) ABSTRACT

There is provided a display control device including a display control unit that displays a plurality of auxiliary images with different compositions together with a predetermined image.

### BACKGROUND

The present disclosure relates to a display control device, a display control method, a program, and a recording medium.

One of methods of imaging a photograph giving a good impression to viewers is setting of a composition. Japanese Unexamined Patent Application

Publication No. 2009-231992 discloses a technology for automatically determining a composition determined to be the best composition in an imaging device and presenting an image based on the composition.

### SUMMARY

According to the technology disclosed in Japanese Unexamined Patent Application Publication No. 2009-231992, the composition is automatically determined in the imaging device. Therefore, since it is not necessary for a user to determine the composition, convenience is improved. However, a composition automatically determined in an imaging device may not necessarily be a composition in which an inclination or preference of the user is reflected.

It is desirable to provide a display control device, a display control method, a program, and a recording medium that display a plurality of auxiliary images with different compositions.

According to an embodiment of the present disclosure, there is provided a display control device including a display control unit that displays a plurality of auxiliary images with different compositions together with a predetermined image.

According to an embodiment of the present disclosure, there is provided a display control method in a display control device, the method including displaying a plurality of auxiliary images with different compositions together with a predetermined image.

According to an embodiment of the present disclosure, there is provided a program causing a computer to perform a display control method in a display control device, the method including displaying a plurality of auxiliary images with different compositions together with a predetermined image, or a recording medium having a program recorded thereon.

According to at least one embodiment, a plurality of auxiliary images with different compositions can be displayed. A user can refer to the plurality of compositions by viewing the plurality of displayed auxiliary images.

### BRIEF DESCRIPTION OF THE DRAWINGS

FIG. 1 is a diagram illustrating an example of the outer appearance of an imaging device according to an embodiment;

FIG. 2 is a diagram illustrating an example of the configuration of the imaging device according to the embodiment;

FIG. 3 is a diagram illustrating an example of a process of generating auxiliary images;

FIG. 4 is a diagram illustrating an example of a through image displayed on a display unit;

FIG. 5 is a diagram illustrating examples of the through image and auxiliary images displayed on the display unit;

FIG. 6 is a diagram illustrating an example of a form in which the edge of a selected auxiliary image is displayed so as to overlap the through image;

FIG. 7 is a diagram illustrating an example of a form in which an image for which transparency of the selected auxiliary image is changed is displayed so as to overlap the through image;

FIG. 8 is a flowchart illustrating an example of the flow of a process;

FIG. 9 is a diagram illustrating display of auxiliary images and the like according to a modification example;

FIG. 10 is a diagram illustrating an example of the configuration of an imaging device according to a modification example;

FIG. 11 is a diagram illustrating display of auxiliary images and the like according to a modification example;

FIG. 12 is a diagram illustrating the display of the auxiliary images and the like according to the modification example; and

FIG. 13 is a diagram illustrating another example of the configuration of an imaging device according to a modification example.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments of the present disclosure will be described with reference to the drawings. The description will be made in the following order.

### 1. Embodiment

### 2. Modification Examples

An embodiment and the like to be described below are specific preferred examples of the present disclosure and the contents of the present disclosure are not limited to the embodiment and the like.

### 1. Embodiment

### [Outer Appearance of Imaging Device]

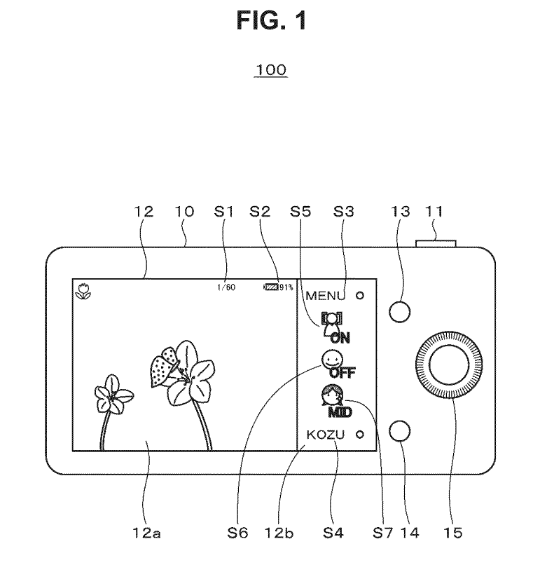

First, an embodiment of the present disclosure will be described. The embodiment is an example in which a display control device is applied to an imaging device. FIG. 1 is a diagram illustrating an example of the outer appearance of an imaging device 100 according to the embodiment. The imaging device 100 includes a body (casing) 10. A release button (also referred to as a shutter button or the like) 11 is formed on the body 10. For example, a two-stage pressing operation of a half-pressing stage and a full-pressing stage can be considered to be performed on the release button 11.

A display unit 12 is installed on one side surface of the body 10. A through image with a predetermined composition, an image reproduced by a recording device, or the like is displayed on the display unit 12. For example, the display unit 12 includes a touch panel, and thus an input operation on the display unit 12 can be performed. A menu screen or an operation screen used to perform various settings is displayed on the display unit 12 in addition to the above-mentioned images.

A display region of the display unit 12 is divided into, for example, display regions 12a and 12b. The display region 12a is considered to be larger than the display region 12b. For example, a through image is displayed in the display region 12a. For example, numbers or icons in addition to a through image are displayed in the display region 12a. For example, a number S1 indicating a frame rate of the imaging device 100 and an icon S2 indicating a remaining amount of battery mounted on the imaging device 100 are displayed in the display region 12a.

Icons, characters, and the like are displayed in the display region 12b. For example, characters S3 of “MENU” and characters S4 of “KOZU (composition)” are displayed. When the characters S3 (appropriately referred to as a MENU button S3) of MENU are touched by a finger of a user or the like, a menu screen is displayed on the display unit 12.

When the characters S4 (appropriately referred to as a KOZU button S4) of KOZU are touched by a finger of a user or the like, a plurality of auxiliary images are displayed. The plurality of auxiliary images are auxiliary images for determination of compositions. The compositions of the plurality of auxiliary images are different from each other. The user refers to the plurality of auxiliary images to determine a preferred composition. The composition is also referred to as framing and refers to a disposition state of a subject within an image frame. The display or the like of the auxiliary images will be described in detail below.

An icon S5 indicating a face detection function, an icon S6 indicating a function of automatically detecting a smiley face and imaging the smiley face, and an icon S7 indicating a beautiful skin correction function of detecting the region of facial skin and whitening the detected region so that specks or rough skin are unnoticeable are displayed in the display region 12b. When the user touches one of the icons, ON and OFF of the function corresponding to the touched icon can be switched. The kinds of icons and the displayed positions of the icons can be appropriately changed.

Physical operation units may be provided near the position at which the MENU button S3 and the KOZU button S4 are displayed. For example, a button 13 is provided at a position near the MENU button S3 on the body 10. The menu screen is displayed on the display unit 12 according to a press of the button 13. A button 14 is provided at a position near the KOZU button S4 on the body 10. The plurality of auxiliary images are displayed on the display unit 12 according to a press of the button 14.

A substantially circular dial button 15 is also provided on the body 10. The circumferential portion of the dial button 15 is considered to be rotatable and the central portion of the dial button 15 is considered to be pressed down. By rotating the circumferential portion of the dial button 15, for example, items displayed on the display unit 12 can be changed. When a given item is selected and the central portion of the dial button 15 is pressed down, the selection of this item is confirmed.

Then, a function assigned to this item is performed. Further, when one auxiliary image is selected from the plurality of auxiliary images to be described below, the dial button 15 may be used.

The above-described outer appearance of the imaging device 100 is merely an example and the embodiment of the present disclosure is not limited thereto. For example, when the imaging device 100 has a function of capturing a moving image, a REC button used to capture and record the moving image may be provided on the body 10. Further, a play button used to play back a still image or a moving image obtained after the imaging may be provided on the body 10.

### [Configuration of Imaging Device]

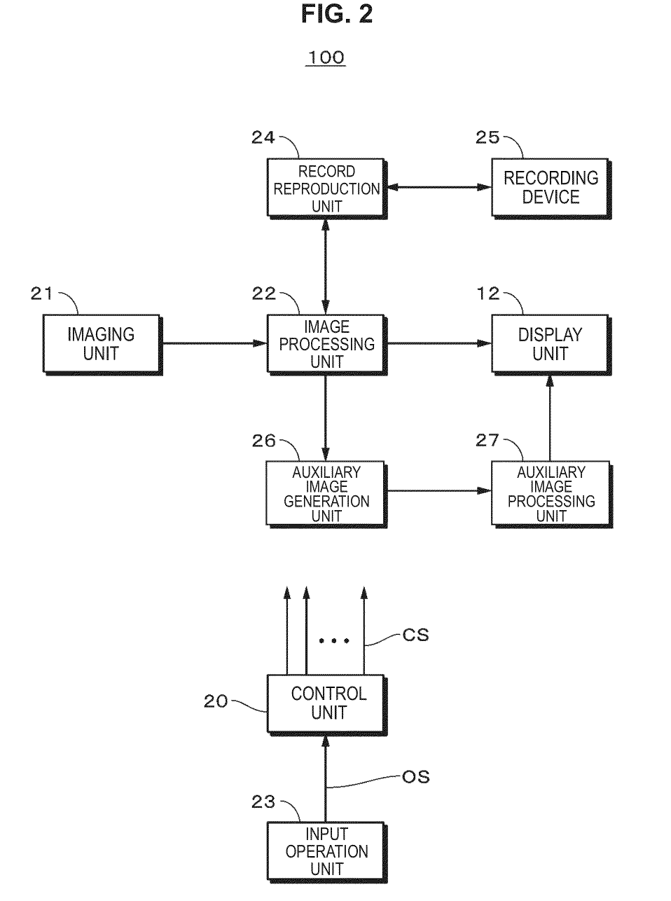

FIG. 2 is a diagram illustrating an example of the main configuration of the imaging device 100. The imaging device 100 includes not only the display unit 12 but also, for example, a control unit 20, an imaging unit 21, an image processing unit 22, an input operation unit 23, a record reproduction unit 24, a recording device 25, an auxiliary image generation unit 26, and an auxiliary image processing unit 27. For example, a display control unit includes the auxiliary image generation unit 26 and the auxiliary image processing unit 27. Hereinafter, each unit will be described.

For example, the control unit 20 includes a central processing unit (CPU) and is electrically connected to each unit of the imaging device 100. The control unit 20 includes a read-only memory (ROM) and a random access memory (RAM). The ROM stores a program executed by the control unit 20. The RAM is used as a memory that temporarily stores data or a work memory when the control unit 20 executes a program. In FIG. 2, connection between the control unit 20 and each unit of the imaging device 100, the ROM, and the random access memory (RAM) is not illustrated. A control signal CS transmitted from the control unit 20 is supplied to each unit of the imaging device 100, and thus each unit of the imaging device 100 is controlled.

For example, the imaging unit 21 includes a lens that images a subject, an imaging element such as a charge coupled device (CCD) or a complementary metal oxide semiconductor (CMOS), a mechanism that drives the imaging element to a predetermined position or a mechanism that adjusts a stop, a mechanism that adjusts focus, a mechanism that adjusts zoom, and a mechanism that corrects camera-shake.

The lens, the imaging element, and each mechanism are controlled by, for example, the control unit 20. A frame rate of the imaging device 100 is considered to be, for example, 60 f/s (frame per second).

For example, the image processing unit 22 includes an analog signal processing unit, an analog-to-digital (A/D) conversion unit, and a digital signal processing unit. The analog signal processing unit performs a correlated double sampling (CDS) process on analog image data obtained by a photoelectric conversion function of the imaging element to improve a signal-to-noise ratio (S/N ratio) and performs an automatic gain control (AGC) process to control a gain. The analog image data subjected to the analog signal processing is converted into digital image data by the A/D conversion unit. The digital image data is supplied to the digital signal processing unit. The digital signal processing unit performs camera signal processing such as a de-mosaic process, an auto focus (AF) process, an auto exposure (AE) process, and an auto white balance (AWB) process on the digital image data.

The image processing unit 22 stores the image data subjected to the above-described processes in a frame memory (not shown). The image processing unit 22 appropriately converts the size of the image data stored in the frame memory according to the display region of the display unit 12. The image data with the converted size is displayed as a through image on the display unit 12. Image data is supplied in the frame memory according to the frame rate of the imaging device 100 and the image data is sequentially overwritten.

When imaging is performed, the image data processed by the image processing unit 22 is converted and compressed in correspondence with a predetermined format. The image data subjected to the compression and the like is supplied to the record reproduction unit 24. Examples of the predetermined format include a design rule for camera file system (DCF) and an exchangeable image file format for digital still camera (Exif). Joint Photographic Experts Group (JPEG) is exemplified as a compression type. The image processing unit 22 performs a decompression process on the image data supplied from the record reproduction unit 24. The image data subjected to the decompression process is supplied to the display unit 12, and then an image based on the image data is reproduced.

The input operation unit 23 is a generic name for the release button 11, the button 13, and the like described above. An operation signal OS is generated according to an operation on the input operation unit 23. The operation signal OS is supplied to the control unit 20. The control unit 20 generates the control signal CS according to the contents of the operation signal OS. The control signal CS is supplied to a predetermined processing block. When the predetermined processing block operates according to the control signal CS, a process corresponding to the operation on the input operation unit 23 is performed.

The record reproduction unit 24 is a driver that performs recording and reproduction on the recording device 25. The record reproduction unit 24 records the image data supplied from the image processing unit 22 on the recording device 25. When an instruction to reproduce a predetermined image is given, the record reproduction unit 24 reads the image data corresponding to the predetermined image from the recording device 25 and supplies the read image data to the image processing unit 22. For example, some of the processes, such as a process of compressing the image data and a process of decompressing the image data, performed by the image processing unit 22 may be performed by the record reproduction unit 24.

The recording device 25 is, for example, a hard disk that is included in the imaging device 100. The recording device 25 may be a semiconductor memory or the like detachably mounted on the imaging device 100. The recording device 25 records, for example, the image data and audio data such as background music (BGM) reproducible together with an image.

The display unit 12 includes a monitor that includes a liquid crystal display (LCD) and an organic electro-luminescence (EL) and a driver that drives the monitor. When the driver operates to realize display based on the image data supplied from the image processing unit 22, a predetermined image is displayed on the monitor.

When image data (appropriately referred to as auxiliary image data) of the auxiliary image is supplied from the auxiliary image processing unit 27 to the display unit 12, the driver operates to display the auxiliary image based on the auxiliary image data, and thus the auxiliary image is displayed on the monitor. When data indicating information corresponding to a selected auxiliary image is supplied from the auxiliary image processing unit 27 to the display unit 12, the drive operates so that display based on this data is performed so as to overlap a predetermined image. The information corresponding to the selected auxiliary image is, for example, information indicating the contour (edge) of the selected auxiliary image or information on an image in which transparency of the selected auxiliary image is changed.

For example, the display unit 12 includes a touch panel of an electrostatic capacitance type and functions as the input operation unit 23. The display unit 12 may include a touch panel of another type such as a resistive film type or an optical type. The operation signal OS is generated according to an operation of touching a predetermined position on the display unit 12 and the operation signal OS is supplied to the control unit 20. The control unit 20 generates the control signal CS according to the operation signal OS. The control signal CS is supplied to a predetermined processing block and a process is performed according to an operation.

The auxiliary image generation unit 26 generates the auxiliary images with a plurality of different compositions based on a predetermined image. For example, when the KOZU button S4 is pressed down, the control signal CS generated according to the pressing operation is supplied to the image processing unit 22 and the auxiliary image generation unit 26. The image processing unit 22 supplies the image data stored in the frame memory to the auxiliary image generation unit 26 according to the control signal CS. The auxiliary image generation unit 26 generates the plurality of auxiliary image data based on the supplied image data. The generated plurality of auxiliary image data are supplied to the auxiliary image processing unit 27. The original image data from which the plurality of auxiliary image data are generated is sometimes referred to as original image data.

The auxiliary image processing unit 27 temporarily retains the plurality of auxiliary image data supplied from the auxiliary image generation unit 26 in a memory (not shown). The auxiliary image processing unit 27 supplies the plurality of auxiliary image data to the display unit 12. The plurality of auxiliary images based on the auxiliary image data are displayed on the display unit 12.

One auxiliary image is selected from the plurality of auxiliary images using the input operation unit 23. The operation signal OS indicating the selection is supplied to the control unit 20. The control unit 20 generates the control signal CS corresponding to the operation signal OS indicating the selection and supplies the generated control signal CS to the auxiliary image processing unit 27.

The auxiliary image processing unit 27 reads predetermined auxiliary image data instructed by the control signal CS from the memory. The auxiliary image processing unit 27 performs, for example, an edge detection process on the auxiliary image data read from the memory. Image data (appropriately referred to as edge image data) indicating the edge is supplied to the display unit 12. For example, an edge image based on the edge image data is displayed to overlap the through image. As the edge detection process, for example, a known process such as a process of applying a differential filter on the image data or a process of extracting an edge through template matching can be applied.

Another process may be performed on the selected auxiliary image data. The auxiliary image processing unit 27 performs, for example, a transparency changing process on the auxiliary image data read from the memory. An image based on the image data with the changed transparency is displayed to overlap the through image. Such a process is referred to as alpha blend or the like. The transparency may be considered to be constant or may be set by the user. Further, the transparency may be changed in real time according to a predetermined operation.

### [Process of Imaging Device]

An example of a process of the imaging device 100 will be described. The imaging device 100 performs the same process as an imaging device of the related art. Such a process will appropriately not be described. An example of a process relevant to the embodiment of the present disclosure will be described.

The imaging device 100 is oriented toward a subject. The imaging device 100 held with the hand of the user may be oriented toward the subject or the imaging device 100 fixed by a tripod stand or the like may be oriented toward the subject. A through image is displayed on the display region 12a of the imaging device 100. The KOZU button S4 and the like are displayed on the display region 12b. The user determines a composition, while confirming the through image. When it is not necessary to confirm the other compositions, the user presses down the release button 11 to perform normal imaging.

When the user confirms the other compositions, the user can perform an operation to touch the KOZU button S4. The image data stored in the frame memory is supplied as the original image data from the image processing unit 22 to the auxiliary image generation unit 26 according to the touch of the KOZU button S4.

The auxiliary image generation unit 26 generates the plurality of auxiliary image data based on the original image data. The generated plurality of auxiliary image data are supplied to the auxiliary image processing unit 27. The plurality of auxiliary image data are supplied from the auxiliary image processing unit 27 to the display unit 12. The plurality of auxiliary images based on the plurality of auxiliary image data are displayed on the display unit 12. When the plurality of auxiliary images with different compositions are displayed, the user can confirm various compositions.

An operation of selecting a predetermined auxiliary image from the plurality of auxiliary images displayed on the display unit 12 is performed. The operation signal OS corresponding to the selection operation is supplied to the control unit 20. The control unit 20 generates the control signal CS corresponding to the operation signal OS and supplies the control signal CS to the auxiliary image processing unit 27. The auxiliary image processing unit 27 reads the auxiliary image data indicated by the control signal CS from the memory. The auxiliary image processing unit 27 performs, for example, the edge detection process on the auxiliary image data read from the memory to generate the edge image data. The edge image data is supplied to the display unit 12, and thus an edge image is displayed on the display unit 12. For example, the edge image is displayed to overlap the through image.

The edge image displayed on the display unit 12 is presented as an imaging guide. The user moves the imaging device 100 so that the subject in the through image substantially matches the edge indicated by the edge image. Then, when the subject substantially matches the edge indicated by the edge image, the user presses down the release button 11 to perform the imaging. The user can take a photograph with the composition substantially identical to the composition of the selected auxiliary image. As will be described in detail, in an embodiment, direction information (a direction guide) indicating a movement direction of the imaging device 100 is displayed for each of the plurality of auxiliary images.

### [Generation of Auxiliary Image Data]

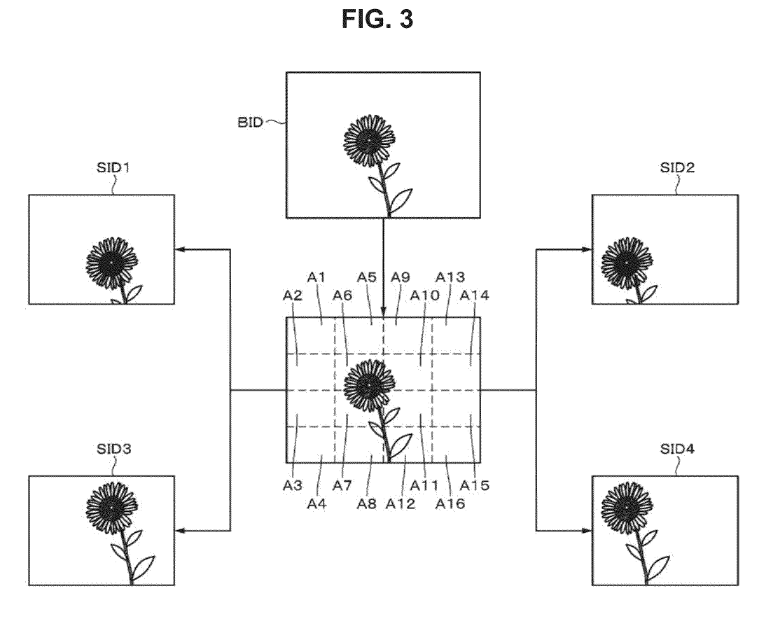

An example of generating the auxiliary image data will be described with reference to FIG. 3. The image data acquired by the imaging unit 21 and subjected to the signal processing by the image processing unit 22 is stored in the frame memory. The size of the image data stored in the frame memory is appropriately converted. An image based on the converted image data is displayed as a through image. The image data stored in the frame memory is appropriately updated according to a frame rate of the imaging device 100. When the KOZU button S4 is pressed down, the image data stored in the frame memory is supplied as the original image data BID to the auxiliary image generation unit 26.

For example, the auxiliary image generation unit 26 divides the original image data BID into 16 regions of 4×4 (a region A1, a region A2, a region A3, a region A4, a region A5, a region A6, . . . , a region A15, and a region A16). For example, the auxiliary image generation unit 26 cuts out the original image data BID into 9 regions of 3×3 and generates 4 pieces of auxiliary image data (auxiliary image data SID1, auxiliary image data SID2, auxiliary image data SID3, and auxiliary image data SID4).

For example, the auxiliary image data SID 1 is formed in 9 regions (the region A1, the region A2, the region A3, the region A5, the region A6, the region A7, the region A9, the region A10, and the region A11) on the upper left side of the drawing. For example, the auxiliary image data SID2 is formed on 9 regions (the region A5, the region A6, the region A7, the region A9, the region A10, the region A11, the region A13, the region A14, and the region A15) on the upper right side of the drawing.

For example, the auxiliary image data SID3 is formed of 9 regions (the region A2, the region A3, the region A4, the region A6, the region A7, the region A8, the region A10, the region A11, and the region A12) on the lower left side of the drawing. For example, the auxiliary image data SID4 is formed in 9 regions (the region A6, the region A7, the region A8, the region A10, the region A11, the region A12, the region A14, the region A15, and the region A16) on the lower right side of the drawing. When it is not necessary to individually distinguish the auxiliary image data from each other, the auxiliary image data are referred to as the auxiliary image data SID.

When the auxiliary image data SID is generated, direction guide data is generated according to the cutout position. A direction guide to be described below is displayed based on the direction guide data. For example, the direction guide data indicating the upper left side is generated and the generated direction guide data can correspond to the auxiliary image data SID1. For example, the direction guide data indicating the upper right side is generated and the generated direction guide data can correspond to the auxiliary image data SID2.

For example, the direction guide data indicating the lower left side is generated and the generated direction guide data can correspond to the auxiliary image data SID3. For example, the direction guide data indicating the lower right side is generated and the generated direction guide data can correspond to the auxiliary image data SID4.

The size of the auxiliary image data SID is appropriately converted such that the size of the auxiliary image data SID is suitable for the display unit 12. The auxiliary image data SID is supplied to the auxiliary image processing unit 27. The 4 pieces of auxiliary image data SID are each stored temporarily in the memory so that the auxiliary image data SID can be processed by the auxiliary image processing unit 27. The 4 pieces of auxiliary image data SID are supplied to the display unit 12. An auxiliary image SI based on each auxiliary image data SID is displayed on the display unit 12. The direction guide which is based on the direction guide data is displayed in correspondence with each auxiliary image SI.

The number of auxiliary image data SID is not limited to 4. A range cut out from the original image data BID is also not limited to 9 regions, but may be appropriately changed. Even when the button 14 is pressed down rather than the KOZU button S4, the auxiliary image data SID are likewise generated and the auxiliary images SI are displayed on the display unit 12.

In the method exemplified in FIG. 3, a subject near the center of the original image is disposed near the intersection point of division lines of the regions of the auxiliary images SI, and the auxiliary images are generated. Therefore, it is possible to prevent generation of an auxiliary image with an inappropriate composition such as a composition in which the subject near the center of the original image is out of an image frame. The appropriate auxiliary images can be generated by a relatively simple algorithm.

### [Example of Display of Auxiliary Images]

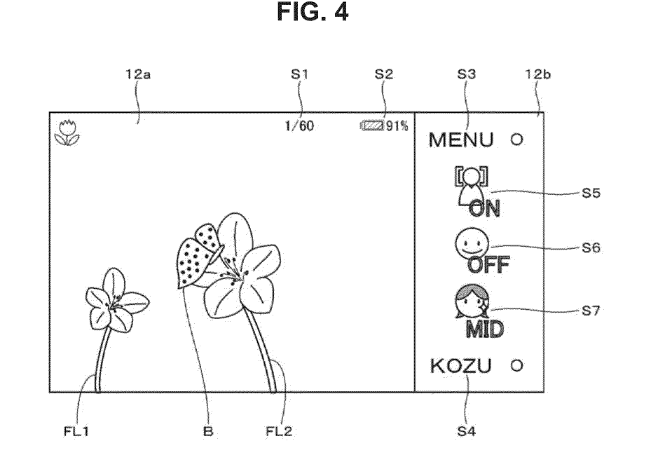

An example of display of the auxiliary images will be described with reference to FIGS. 4, 5, and 6. The imaging device 100 is oriented toward a predetermined subject. A through image including the predetermined subject is displayed on the display unit 12. FIG. 4 is a diagram illustrating an example of the through image and the like displayed on the display unit 12. For example, the through image is displayed on the display region 12a. As described above, the plurality of icons and the like are displayed together with the through image on the display unit 12. For example, the subject includes two flowers and a butterfly. Accordingly, as the through image, a flower image FL1, a flower image FL2, and an image B of the butterfly resting on the flower image FL2 are displayed on the display region 12a. When the user desires to confirm other compositions, the user presses down the KOZU button S4.

When the user presses down the KOZU button S4, the image stored in the frame memory is supplied as the original image data BID to the auxiliary image generation unit 26. Then, for example, four pieces of auxiliary image data SID are generated according to the above-described method and the auxiliary images SI are displayed based on the auxiliary image data SID.

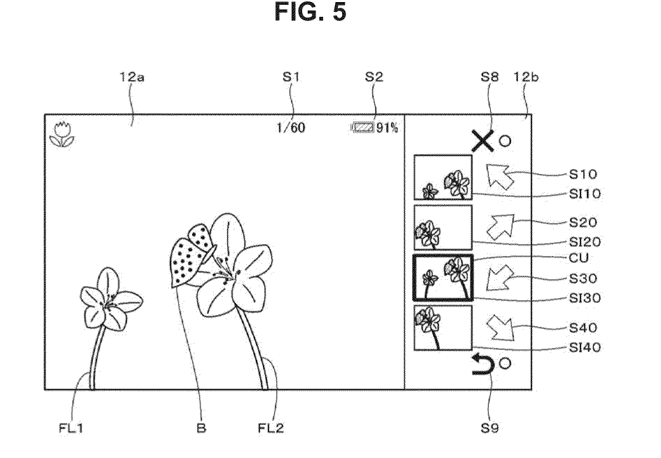

As shown in FIG. 5, for example, four auxiliary images (an auxiliary image SI10, an auxiliary image SI20, an auxiliary image SI30, and an auxiliary image SI40) are displayed in the display region 12b. The user can confirm the other compositions simultaneously. The four auxiliary images may be switched and displayed. A method of displaying the plurality of auxiliary images together with the through image includes a method of switching and displaying the plurality of auxiliary images. Further, when it is not necessary to individually distinguish the auxiliary images, the auxiliary images are referred to as the auxiliary images SI.

Each auxiliary image SI is displayed in correspondence with the direction guide. The direction guide is information guiding a direction in which the user moves the imaging device 100 (the imaging unit 21) when the user performs imaging according to the composition corresponding to the auxiliary image SI. For example, the auxiliary image SI10 is displayed in correspondence with the direction guide S10 indicating the upper left direction. For example, the auxiliary image SI20 is displayed in correspondence with the direction guide S20 indicating the upper right direction. For example, the auxiliary image SI30 is displayed in correspondence with the direction guide S30 indicating the lower left direction. For example, the auxiliary image SI40 is displayed in correspondence with the direction guide S40 indicating the lower right direction.

An erasing button S8 and a return button S9 are displayed in the display region 12b. When the erasing button S8 is touched, for example, the auxiliary image SI is erased. When the return button S9 is touched, for example, a screen is transitioned to the immediately previous screen.

The user selects an auxiliary image with a preferred composition by referring to the four auxiliary images. For example, as shown in FIG. 5, the user performs an operation (appropriately referred to as a tap operation) of touching the auxiliary image SI30 once to select the auxiliary image SI30. A cursor CU is displayed in the circumference of the selected auxiliary image SI30 so that the selected auxiliary image SI30 can be distinguished from the other auxiliary images SI. The user performs an operation (appropriately referred to as a double tap operation) of touching the auxiliary image SI30 twice successively to confirm the selection of the auxiliary image SI30.

The tap operation may not necessarily be performed. For example, the user can select the auxiliary image SI10 by performing a double tap operation on the auxiliary image SI (for example, the auxiliary image SI10) in which the cursor CU is not displayed and confirm the selection of the auxiliary image SI10.

A tap operation on the auxiliary image SI is sometimes referred to as an auxiliary image selection operation and a double tap operation on the auxiliary image SI is sometimes referred to as an auxiliary image decision operation.

For example, information corresponding to the selected auxiliary image SI30 overlaps the through image. In the embodiment, the information corresponding to the auxiliary image SI30 includes information indicating the edge of the auxiliary image SI30 and information on an image for which the transparency of the auxiliary image SI30 is changed. These two pieces of information can be switched and displayed.

The auxiliary image processing unit 27 reads the auxiliary image data SID30 corresponding to the auxiliary image SI30 from the memory according to the selection of the auxiliary image SI30. The auxiliary image processing unit 27 performs an edge detection process on the auxiliary image data SID30. Edge image data is generated through the edge detection process. The size of the edge image data is appropriately converted. The edge image data is supplied to the display unit 12. An edge image based on the edge image data is displayed so as to overlap the through images.

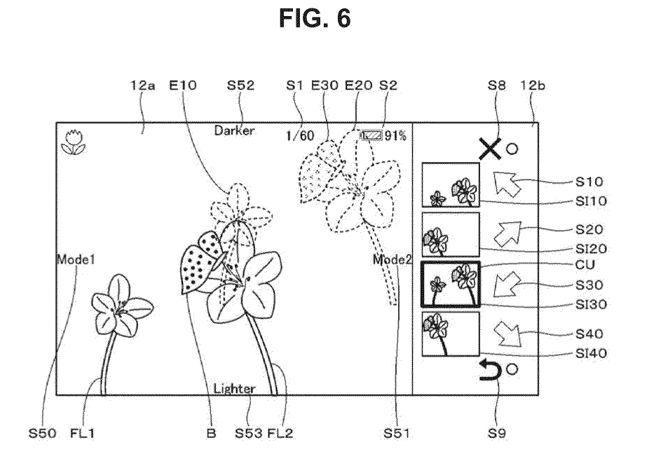

As shown in FIG. 6, an edge E10 indicating the edge of the flower image FL1, an edge E20 indicating the edge of the flower image FL2, and an edge E30 indicating the edge of the image B of the butterfly are displayed at predetermined positions in the display region 12a. The edges are indicated by dotted lines in FIG. 6, but the edges may be displayed by solid lines or the like colored with red or the like.

The user moves the imaging device 100 so that the subject in the through image matches the edges. It is not necessary for the subject in the through image to completely match the edges. When the subject in the through image substantially matches the edges, a photo with a composition substantially identical to the composition of the auxiliary image SI30 can be obtained.

For example, the user moves the imaging device 100 so that the flower image FL1 substantially matches the edge E10. The user may move the imaging device 100 so that the flower image FL2 substantially matches the edge E20 or the image B of the butterfly substantially matches the edge E30.

The auxiliary image SI 30 is displayed in correspondence with the direction guide S30. The user may move the imaging device 100 in the direction indicated by the direction guide S30. Because the direction guide S30 is displayed, for example, it is possible to prevent the user from erroneously moving the imaging device 100 in the upper right direction in which the edge E20 or the like is displayed. After the user moves the imaging device 100 so that the subject in the through image substantially matches the edges, the user presses down the release button 11 to perform the imaging.

A sign S50 of characters “Model” and a sign S51 of characters “Mode2” are displayed in the display region 12a. For example, the sign S50 is displayed in the middle portion of the left side of the display region 12a. The sign S51 is displayed in the middle portion of the right side of the display region 12a. Model (mode 1) indicated by the sign S50 is a button for displaying the edge of the selected auxiliary image. Mode2 (mode 2) indicated by the sign S51 is a button for displaying an image for which the transparency of the selected auxiliary image is changed.

For example, when the user performs an operation of touching the display S51 in the state in which the edge E10 and the like are displayed, the transparency of the auxiliary image SI30 is changed instead of the edge E10 and the like, but the image is displayed so as to overlap the through image. When the user performs an operation of touching the sign S50, the transparency of the auxiliary image SI30 is changed, but the edge image is displayed so as to overlap the through image instead of the image.

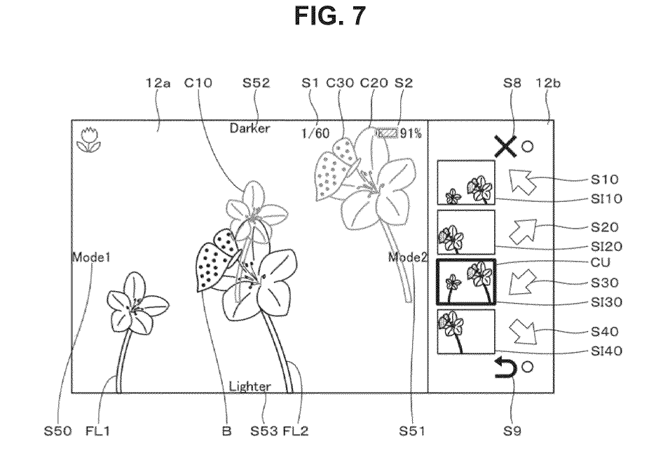

FIG. 7 is a diagram illustrating a form in which the transparency of the auxiliary image SI30 is changed, but the image is displayed so as to overlap the through image. The transparency of the auxiliary image SI30 is changed, but the image includes a flower image C10, a flower image C20, and an image C30 of the butterfly. For example, the user moves the imaging device 100 to perform the imaging so that the flower image C10 substantially matches the flower image FL1.

A sign S52 of characters “Darker” and a sign S53 of characters “Lighter” are displayed in the display region 12a. For example, shading of the display of the edge E10 and the like can be changed through an operation on the signs S52 and S53. For example, when the user performs an operation (appropriately referred to as a holding operation) of continuously touching the sign S52 in the state in which the edge E10 and the like are displayed, the denseness of the display of the edge such as the edge E10 is darkened. For example, when the user performs a holding operation on the sign S53 in the state in which the edge E10 and the like are displayed, the denseness of the display of the edge such as the edge E10 is lightened. The shading is smoothly changed through the hold operation on the sign S52 or the sign S53.

For example, when the user performs the hold operation on the sign S52 in the state in which the image for which the transparency is changed is displayed, the transparency of the flower image C10 and the like is changed to decrease and display is realized based on the changed transparency. For example, when the user performs the hold operation on the sign S53 in the state in which the image for which the transparency is changed is displayed, the transparency of the flower image C10 and the like is changed to increase and display is realized based on the changed transparency. Thus, the transparency can be changed in real time through the operation on the signs S52 and S53. The processes corresponding to the operations on the signs S51, S52, S53, and S54 are performed by, for example, the auxiliary image processing unit 27.

### [Flow of Process]

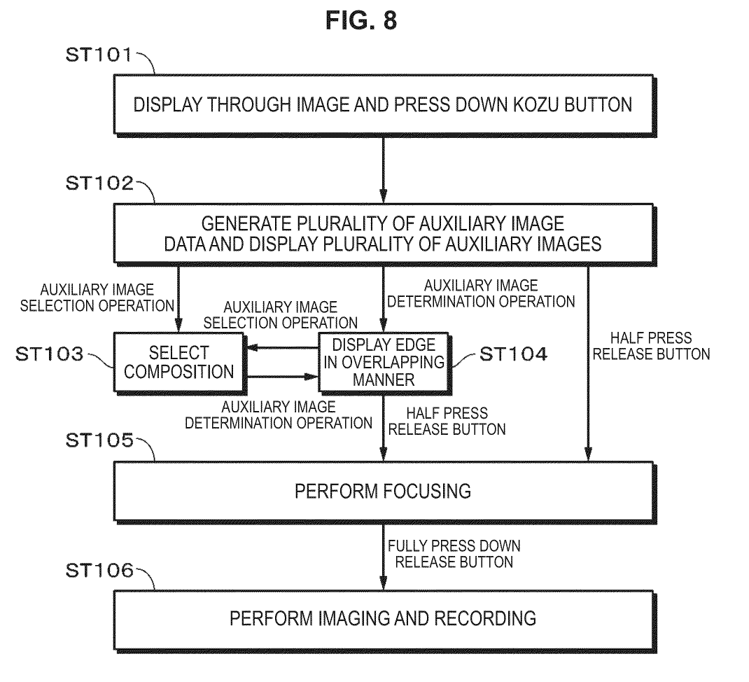

FIG. 8 is a flowchart illustrating an example of the flow of the process of the imaging device 100. In step ST101, the imaging device 100 is oriented toward a subject and the subject with a predetermined composition is displayed on the display unit 12. The user presses down the KOZU button S4 while confirming the through image. Then, the process proceeds to step ST102.

In step ST102, the plurality of auxiliary image data SID are generated. The auxiliary images SI corresponding to the plurality of auxiliary image data SID are displayed on the display unit 12. The user can confirm the other compositions by referring to the plurality of auxiliary images SI. When the user does not desire the compositions presented with the auxiliary images but desires the original composition (the composition of the through image), the user half presses the release button 11. When the user half presses the release button 11, the process proceeds to step ST105.

In step ST105, a focusing process is performed. When the user further fully presses down the release button 11, the process proceeds to step ST106 to perform the imaging. The captured image data is recorded in the recording device 25. Thus, even when the user confirms the other compositions by referring to the plurality of auxiliary images, the user can capture the image based on the through image with a predetermined composition. It is not necessary to perform an operation of erasing the auxiliary image, the direction guide, and the like.

When the auxiliary image selection operation is performed in step ST102, the process proceeds to step ST103. The cursor CU is displayed in the circumference of the operated auxiliary image, and thus the composition of the auxiliary image is selected. When the auxiliary image decision operation is performed, the process proceeds to step ST104.

In step ST104, the selection of the auxiliary image is confirmed, the information corresponding to the selected auxiliary image is displayed in the overlapping manner. For example, the edge image based on the selected auxiliary image is displayed so as to overlap the through image. As described above, the image for which the transparency of the selected auxiliary image is changed may be displayed so as to overlap the through image. When the auxiliary image selection operation is performed on the auxiliary image different from the selected auxiliary image in step ST104, the process proceeds to step ST103. The cursor CU is displayed in the circumference of the auxiliary image subjected to the auxiliary image selection operation.

When the auxiliary image decision operation is performed in step ST102, the process proceeds to step ST104 and the edge image based on the auxiliary image subjected to the auxiliary image decision operation is displayed so as to overlap the through image.

The imaging device 100 is moved so that the subject in the through image substantially matches the edges. The user can easily recognize the movement direction of the imaging device 100 by referring to the direction guide. When the subject substantially matches the edges, the user half presses the release button 11. Then, the process proceeds to step ST105.

In step ST105, a focusing process is performed. When the user further fully presses down the release button 11, the process proceeds to step ST106 to perform the imaging. The captured image data is recorded in the recording device 25. Thus, the user can refer to the plurality of compositions. When the user desires a given composition, the edge or the guide such as the direction guide are displayed so that the user can image a photo with the composition. Accordingly, the user can easily image the photo with the desired composition.

### 2. Modification Examples

The embodiment of the present disclosure has been described above. An embodiment of the present disclosure is not limited to the above-described embodiment and may be modified in various forms.

A plurality of auxiliary images may be confirmed with the hand of the user. For example, the imaging device 100 is oriented toward a predetermined subject, and then the KOZU button S4 is pressed down when the predetermined subject is displayed as a through image on the display unit 12. According to a press of the KOZU button S4, image data stored in the frame memory is supplied as original image data to the auxiliary image generation unit 26. The plurality of auxiliary image data based on the original image data are generated by the auxiliary image generation unit 26. The plurality of auxiliary images based on the plurality of auxiliary image data are displayed on the display unit 12.

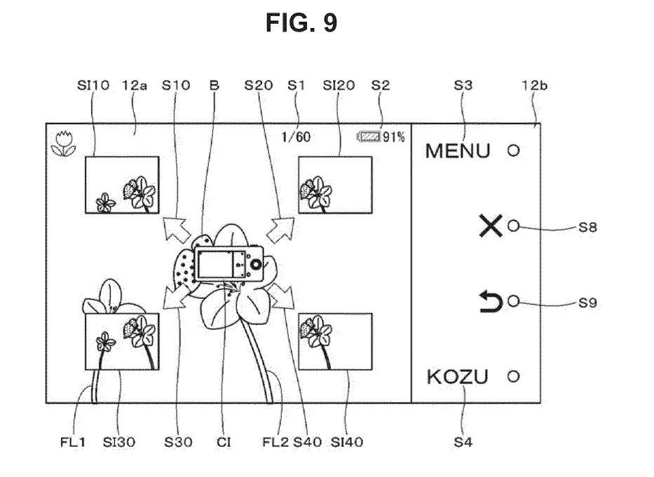

FIG. 9 is a diagram illustrating a display example of the auxiliary images and the like according to a modification example. An icon CI resembling the imaging device 100 is displayed near the center of the display region 12a. Four auxiliary images (an auxiliary image SI10, an auxiliary image SI20, an auxiliary image SI30, and an auxiliary image SI40) are displayed in the display region 12a.

A direction guide S10 is displayed between the auxiliary image SI10 and the icon CI. A direction guide S20 is displayed between the auxiliary image SI20 and the icon CI. A direction guide S30 is displayed between the auxiliary image SI30 and the icon CI. A direction guide S40 is displayed between the auxiliary image SI40 and the icon CI. By displaying the icon CI, the movement direction of the imaging device 100 can be presented more straightforwardly to the user.

The icon CI, the plurality of auxiliary images SI, and the plurality of direction guides are displayed together with the image based on the original image data. For example, the image based on the original image data includes a flower image FL1, a flower image FL2, and an image B of a butterfly. For example, when an operation of touching an erasing button S8 displayed in the display region 12b is executed, the icon CI, the plurality of auxiliary images SI, and the plurality of direction guides are erased. When a return button S9 is touched, the icon CI, the plurality of auxiliary images SI, and the plurality of direction guides are displayed again.

When the plurality of auxiliary images SI are displayed, the user can confirm the other compositions. Further, the user can refer to the composition, that is, the composition of the image based on the original image data, when the user presses down the KOZU button S4. It is not necessary to continuously orient the imaging device 100 toward the subject and the user can refer to the plurality of compositions while holding the imaging device 100. When there is a composition desired by the user, for example, the imaging device 100 is prepared in the same direction as when the KOZU button S4 is pressed down. Then, when the auxiliary image SI with the desired composition is touched, as exemplified in FIG. 6, the edge image is displayed so as to overlap the through image. The user performs the imaging with reference to the edge image.

In the above-described embodiment, the image data obtained through the imaging unit 21 has been described as an example of the original image data, but other image data may be set as the original image data. For example, image data recorded on the recording device 25 may be set as the original image data.

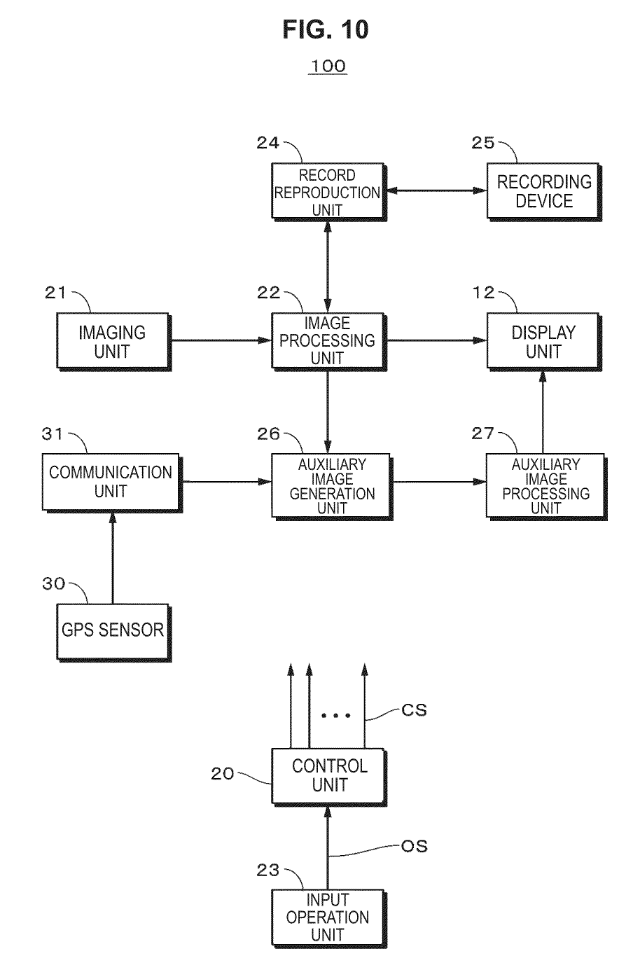

As shown in FIG. 10, the imaging device 100 includes a GPS sensor 30 and a communication unit 31 as an example of a position acquisition unit. The GPS sensor 30 acquires position information on the current position of the imaging device 100. For example, the communication unit 31 communicates with an image server via the Internet. For example, the position information acquired by the GPS sensor 30 is transmitted to the image server according to a predetermined operation of the user. The image server transmits a plurality of image data according to the position information to the imaging device 100.

The plurality of image data transmitted from the image server are received by the communication unit 31. The image data are supplied to the auxiliary image generation unit 26. The auxiliary image generation unit 26 performs, for example, a process of converting the size of each of the plurality of image data. Images based on the processed image data are displayed as the auxiliary images. Image data downloaded from the image server may be configured to be selected by the user.

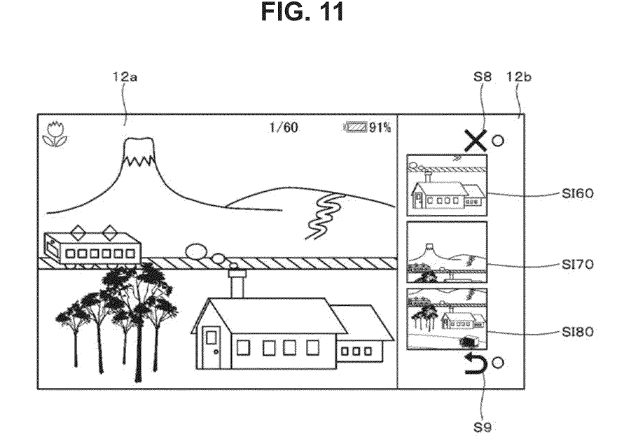

As exemplified in FIG. 11, when the user prepares the imaging device 100 in a given place, a predetermined landscape is displayed in the display region 12a. Images based on the image data transmitted from the image server are displayed as the auxiliary images in the display region 12b. For example, when the landscape is imaged at substantially the same place, an auxiliary image SI60 with a composition centering on a building, an auxiliary image SI70 with a composition centering on a distant landscape such as a mountain or a hill, and an auxiliary image SI80 with a composition centering on trees or a building are displayed. The user determines a composition by referring to such auxiliary images.

When one of the auxiliary images SI is selected, as exemplified in FIG. 6, the edge of the auxiliary image SI is displayed in an overlapping manner. The user can take a photograph with a composition substantially identical to the composition of the selected auxiliary image SI by performing the imaging with reference to the edge. Thus, the imaging can be performed emulating the composition of an existing image.

The communication unit 31 may perform short-range wireless communication. As the communication by a wireless short-range scheme, for example, communication by infrared light, communication by the “Zigbee (registered trademark)” standard, communication by “Bluetooth (registered trademark),” or communication by “WiFi (registered trademark)” that easily forms a network can be used, but embodiments of the present disclosure are not limited thereto. By performing such short-range wireless communication with another device, image data is acquired from the other device. Images based on the image data acquired from the other device may be displayed as auxiliary images. Auxiliary images based on other original image data may be displayed together.

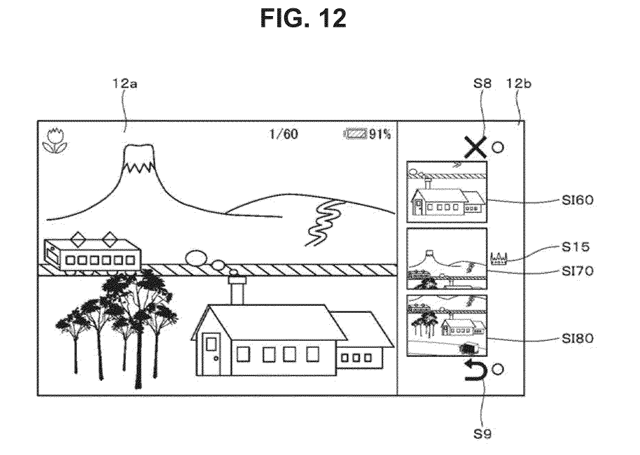

The plurality of auxiliary images may be displayed in a display form according to the evaluation value. The evaluation value is defined by the number of downloads of the image data, the number of submissions of a high evaluation for the image data, or the like. For example, a predetermined mark may be given to the auxiliary image based on the image data of which the number of downloads is large and may be displayed. As exemplified in FIG. 12, a crown mark S15 may be given to the auxiliary image SI70 based on the image data of which the number of downloads is large and may be displayed.

The evaluation value may be determined according to the position of a predetermined subject. The description will be made with reference to the example of FIG. 5. The predetermined subject is a main subject among the plurality of subjects and is, for example, a subject with the largest size. In the example of FIG. 5, the flower image FL2 is set as the predetermined subject. The evaluation value may increase the closer the central position of a region including the flower image FL2 is to the center of the auxiliary image SI. The auxiliary images SI may be arranged in decreasing order of evaluation values. A crown mark or the like may be given to the auxiliary image SI with a large evaluation value and may be displayed. Of course, such display is presented merely as a reference to the user, and thus does not limit the selection of the auxiliary image SI by the user.

In the above-described embodiment, the predetermined operation of generating the auxiliary images has been described as the operation of touching the KOZU button S4 or the operation of pressing down the button 14, but may be an operation performed by audio.

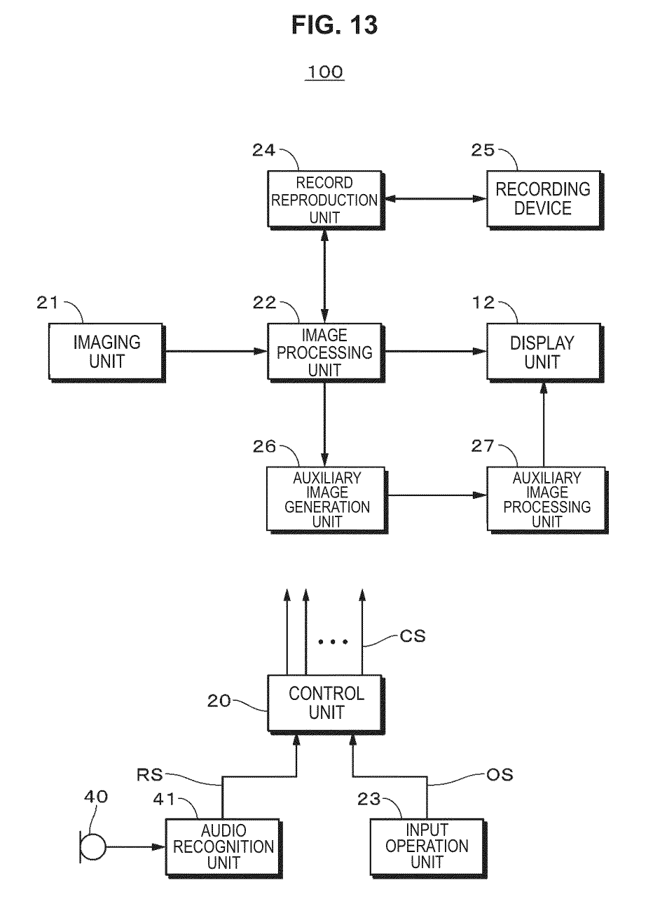

As shown in FIG. 13, the imaging device 100 may include a microphone 40 which is an example of an audio reception unit and an audio recognition unit 41 that recognizes audio received by the audio reception unit. The microphone 40 may be a microphone that receives a sound when a moving image is captured. For example, the user says, for example, “display compositions” toward the microphone 40 while holding the imaging device 100 to display a through image on the display unit 12. A recognition signal RS indicating an audio recognition result of the audio recognition unit 41 is generated.

The recognition signal RS is supplied to the control unit 20. The control unit 20 generates a control signal CS to generate auxiliary images according to the recognition signal RS. The control signal CS is supplied to the auxiliary image generation unit 26. The auxiliary image generation unit 26 generates auxiliary image data according to the control signal CS. As described above in the embodiment, the auxiliary images based on the auxiliary image data are displayed. Further, identification information such as a number may be displayed in correspondence with each of the plurality of auxiliary images. For example, an auxiliary image may be configured to be selected by an audio of “the second auxiliary image.” Thus, the imaging device 100 may be configured to be operated by audio.

When the user performs the imaging, the user prepares the imaging device 100 to face a subject in many cases, holding the imaging device 100 with his or her both hands. Even in such cases, the auxiliary images and the edges can be displayed on the display unit 12 without changing the position of the imaging device 100.

The direction guide may be displayed at a timing at which the user moves the imaging device 100. For example, a predetermined auxiliary image may be selected and the direction guide may be displayed at the selection timing. The direction guide may be displayed in the display region 12a. The direction guide may be displayed in a blinking manner. The direction guide may be configured to guide movement by audio.

The display control device according to the embodiment of the present disclosure is not limited to the imaging device 100, but may be realized by a personal computer, a tablet-type computer, a smart phone, or the like. The embodiment of the present disclosure is not limited to a device, but may be realized as a method, a program, or a recording medium.

The configurations and the processes according to the embodiment and the modification examples may be appropriately combined within the scope in which technical inconsistency does not occur. The processing order in the exemplified flow of the processes may be appropriately changed within the scope in which technical inconsistency does not occur.

The embodiment of the present disclosure can be applied to a so-called cloud system in which the exemplified processes are distributed and processed by a plurality of devices. The embodiment of the present disclosure can be realized as a system that performs the exemplified processes and a device that performs at least some of the processes.

It should be understood by those skilled in the art that various modifications, combinations, sub-combinations and alterations may occur depending on design requirements and other factors insofar as they are within the scope of the appended claims or the equivalents thereof

Additionally, the present technology may also be configured as below.
(1) A display control device including:
   a display control unit that displays a plurality of auxiliary images with different compositions together with a predetermined image.
(2) The display control device according to (1), wherein the predetermined image is an image acquired through an imaging unit.
(3) The display control device according to (2), wherein the display control unit generates the plurality of auxiliary images based on the image acquired through the imaging unit.
(4) The display control device according to (2) or (3), wherein the display control unit displays directional information indicating a movement direction of the imaging unit in correspondence with each auxiliary image.
(5) The display control device according to any one of (1) to (4), wherein the display control unit generates the plurality of auxiliary images according to a predetermined operation.
(6) The display control device according to any one of (1) to (5), further including:

an input operation unit that selects one auxiliary image from the plurality of auxiliary images.
(7) The display control device according to (6), wherein the display control unit displays information corresponding to the selected auxiliary image in a manner that the information overlaps the predetermined image.
(8) The display control device according to (7), wherein the information corresponding to the selected auxiliary image is information indicating an edge of the auxiliary image.
(9) The display control device according to (7), wherein the information corresponding to the selected auxiliary image is information on an image for which transparency of the auxiliary image is changed.
(10) The display control device according to (7), wherein the display control unit displays information used to switch the information corresponding to the selected auxiliary image.
(11) The display control device according to any one of (7) to (10), wherein the display control unit displays information used to change a display form of the information corresponding to the selected auxiliary image.
(12) The display control device according to any one of (1) to (11), wherein the display control unit displays the plurality of auxiliary images according to an evaluation value of each auxiliary image.
(13) The display control device according to (12), wherein the evaluation value is determined according to a position of a predetermined subject included in each of the plurality of auxiliary images.
(14) The display control device according to (1), wherein the display control unit generates the plurality of auxiliary images based on an image stored in a storage unit.
(15) The display control device according to (1), further including:
   a position information acquisition unit that acquires position information,
   wherein the display control unit generates the plurality of auxiliary images based on an image acquired according to the position information.
(16) A display control method in a display control device, the method including:
   displaying a plurality of auxiliary images with different compositions together with a predetermined image.
(17) A program causing a computer to perform a display control method in a display control device, the method including displaying a plurality of auxiliary images with different compositions together with a predetermined image.
(18) A recording medium recording the program according to (17).

The present disclosure contains subject matter related to that disclosed in Japanese Priority Patent Application JP 2012-105047 filed in the Japan Patent Office on May 2, 2012, the entire content of which is hereby incorporated by reference.

What is claimed is:

1. A display control device comprising:
a display control unit that displays a plurality of auxiliary images with different compositions together with a predetermined image.

2. The display control device according to claim 1, wherein the predetermined image is an image acquired through an imaging unit.

3. The display control device according to claim 2, wherein the display control unit generates the plurality of auxiliary images based on the image acquired through the imaging unit.

4. The display control device according to claim 2, wherein the display control unit displays directional information indicating a movement direction of the imaging unit in correspondence with each auxiliary image.

5. The display control device according to claim 1, wherein the display control unit generates the plurality of auxiliary images according to a predetermined operation.

6. The display control device according to claim 1, further comprising:
an input operation unit that selects one auxiliary image from the plurality of auxiliary images.

7. The display control device according to claim 6, wherein the display control unit displays information corresponding to the selected auxiliary image in a manner that the information overlaps the predetermined image.

8. The display control device according to claim 7, wherein the information corresponding to the selected auxiliary image is information indicating an edge of the auxiliary image.

9. The display control device according to claim 7, wherein the information corresponding to the selected auxiliary image is information on an image for which transparency of the auxiliary image is changed.

10. The display control device according to claim 7, wherein the display control unit displays information used to switch the information corresponding to the selected auxiliary image.

11. The display control device according to claim 7, wherein the display control unit displays information used to change a display form of the information corresponding to the selected auxiliary image.

12. The display control device according to claim 1, wherein the display control unit displays the plurality of auxiliary images according to an evaluation value of each auxiliary image.

13. The display control device according to claim 12, wherein the evaluation value is determined according to a position of a predetermined subject included in each of the plurality of auxiliary images.

14. The display control device according to claim 1, wherein the display control unit generates the plurality of auxiliary images based on an image stored in a storage unit.

15. The display control device according to claim 1, further comprising:
a position information acquisition unit that acquires position information,
wherein the display control unit generates the plurality of auxiliary images based on an image acquired according to the position information.

16. A display control method in a display control device, the method comprising:
displaying a plurality of auxiliary images with different compositions together with a predetermined image.

17. A program causing a computer to perform a display control method in a display control device, the method including displaying a plurality of auxiliary images with different compositions together with a predetermined image.

18. A recording medium recording the program according to claim 17.
